(19) United States
(12) Patent Application Publication
(10) Pub. No.: US 2025/0282950 A1
(43) Pub. Date: Sep. 11, 2025

(54) POLYURETHANE COMPOSITE MATERIAL WITH EMBEDDED LIQUID HEALING NETWORK AND PREPARATION METHOD THEREFOR

(71) Applicant: China Academy of Machinery Wuhan Research Institute of Materials Protection Co., Ltd., Wuhan (CN)

(72) Inventors: Jun WU, Wuhan (CN); Lulu LIU, Wuhan (CN); Jiangfeng AN, Wuhan (CN); Hao CHEN, Wuhan (CN); Zhijian CHEN, Wuhan (CN); Ying HU, Wuhan (CN); Penghua ZHENG, Wuhan (CN)

(21) Appl. No.: 19/216,910

(22) Filed: May 23, 2025

(30) Foreign Application Priority Data
Jan. 16, 2025 (CN) 202510069661.8

(51) Int. Cl. C08L 75/04; C08J 3/20; C08K 7/20; C08K 9/06

(52) U.S. Cl. CPC C08L 75/04; C08J 3/203; C08K 7/20; C08J 2375/04; C08J 2463/00; C08K 9/06; C08K 2201/011; C08L 2205/04

(57) ABSTRACT

A polyurethane composite material with an embedded liquid healing network and a preparation method therefor are provided. The polyurethane composite material is composed of 40-60 parts of a polyurethane prepolymer. 5-20 parts of healing agent carrier particles. 10-30 parts of a liquid healing agent, and 0.1-1 parts of a dispersant.

### CROSS REFERENCE TO RELATED APPLICATIONS

The present disclosure claims the priority to the Chinese patent application with the filing NO. 2025100696618, entitled “POLYURETHANE COMPOSITE MATERIAL WITH EMBEDDED LIQUID HEALING NETWORK AND PREPARATION METHOD THEREFOR” and filed on Jan. 16, 2025 with the Chinese Patent Office, the contents of which are incorporated herein by reference in their entirety.

### TECHNICAL FIELD

The present disclosure relates to the technical field of polymer materials, and particularly to a polyurethane composite material with an embedded liquid healing network and a preparation method therefor.

### BACKGROUND ART

In modern industry, polyurethane materials are widely used in many fields of automobiles, aerospace, architecture, and electronic equipment, etc. due to their excellent mechanical performances, wear resistance, weather resistance, and good processability. These advantages enable polyurethane materials to be an important component of many high-performance products. However, during long-term use, they may inevitably be affected by the external environment, and especially under high load, high temperature or atrocious climate conditions, the materials are prone to cracks, fatigue or aging. These damages not only affect the service life of the material, but may also cause equipment failure or structural failure, thereby affecting the safety and reliability of the product. Therefore, how to improve the damage resistance of polyurethane materials and prolong their service life has become an important research direction in the field of material science.

With the continuous development of technology, self-healing materials have gradually become one of the hot topics in high-performance material research. Self-healing materials can automatically restore their structure and function after suffering external damage, avoiding the tedious process of traditional repair methods, have high application potential, and have important application prospect especially in the fields of aerospace, automobile, architecture and electronic equipment, etc. Existing self-healing polyurethane materials mainly rely on mechanisms such as dynamic covalent bonds or hydrogen bonds to achieve self-healing. However, in the case of large-area cracks or multiple times of damage, the repair efficiency and material integrity are significantly reduced, mainly because of limited molecular migration and depletion of repair resources. In addition, the performance of such materials under complex chemical environments and extreme temperatures often cannot meet actual needs.

The prior art, invention patent CN 110305466 A, proposes a polyurethane/epoxy resin co-mixture with shape memory and self-healing and recycling functions and its preparation method. The polyurethane/epoxy resin co-mixture is a homogeneous mixture of polyurethane and epoxy resin or a two-phase phase-separated mixture formed by mixing the two together, then cross-linking with a curing agent and curing. Among them, the polyurethane is a linear polyurethane material containing a disulfide bond on the main chain, the epoxy resin is a cyclohydrogen resin prepolymer containing a furan ring on the side group, and the curing agent contains a maleimide group. The preparation method of the polyurethane/epoxy resin homogeneous mixture includes: dissolving the polyurethane and the epoxy resin prepolymer in an organic solvent, stirring and co-mixing at a temperature of 60˜80° C., and drying at a temperature of 60˜80° C. after evenly stirring to obtain it. Through the co-mixing method, this invention improves the shape memory and self-healing and recycling characteristics of the polyurethane material, and enhances the mechanical performance of the polyurethane at room temperature, without affecting the recyclability of the polyurethane at a high temperature. However, it does not solve the problems of multiple times of damage repair, rapid response and performance stability in complex environments, and is not suitable for popularization and application. The prior art invention patent CN 111499833 A introduces, into polyurethane, polythiol containing a disulfide self-healing functional group, to obtain a self-healing polyurethane resin. Although the anti-corrosion performance is considered, the distribution and release mechanism of the healing agent are relatively simple, and the technology does not fully consider the capability of multiple times of repair and long-term environmental adaptability, and is not suitable for popularization and application.

Therefore, it is a technical problem urgently to be solved by a person skilled in the art to provide a polyurethane composite material with an embedded liquid healing network that can achieve rapid and efficient repair in the case of large-scale damage and improve the capability of multiple times of repair and environmental adaptability.

### SUMMARY

In view of this, by embedding a liquid healing network in the polyurethane matrix and utilizing the high fluidity of the liquid healing agent and the controllable release characteristics of the micro-nano carrier, the present disclosure can not only achieve rapid and efficient repair in the case of large-scale damage, but also significantly improve the capability of multiple times of repair and environmental adaptability, providing a new technical solution for the practical application of self-healing materials.

To achieve the above object, the present disclosure adopts the following technical solution.

A polyurethane composite material with an embedded liquid healing network includes the following raw materials in parts by weight:
40-60 parts of polyurethane prepolymer, 5-20 parts of healing agent carrier particles, 10-30 parts of liquid healing agent and 0.1-1 part of dispersant;
where the polyurethane prepolymer is prepared by mixing isocyanate and polyol in a molar ratio of 1.8-2.2:1 under catalyzing of a catalyst; and the amount of the catalyst is 0.5-2 parts; and
the liquid healing agent is prepared by mixing epoxy resin and thiol in a mass ratio of 1-4:1, and is used for a cross-linking reaction at cracks.

Further, the isocyanate is 4,4′-diphenylmethane diisocyanate (MDI), and the polyol is polyether polyol or polyester polyol.

Further, the healing agent carrier particles are modified SiO₂ microspheres, the surface of which is treated with a silane coupling agent to improve the bonding strength with the polyurethane matrix, and the particle size of the microspheres is 10-100 nm.

In the present disclosure, the particle size of the microspheres is controlled within the range of 10-100 nm, because the SiO₂ microspheres in this range are at the nanoscale, which can improve the strength, toughness and impact resistance of the polyurethane matrix. The particle size of less than 10 nm may cause agglomeration of the microspheres, and reduce the dispersibility and enhancement effect; while the particle size of greater than 100 nm may weaken the nano-enhanced interface effect and reduce the uniformity and performance of the material. Meanwhile, that the epoxy resin and the thiol are controlled at a mass ratio of 1-4:1 is because the epoxy groups in the epoxy resin molecules provide cross-linking points, and their ratio directly determines the rigidity and structural stability of the healing network, while the thiol group (—SH) in the thiol reacts rapidly with the epoxy group to form a flexible chain segment, increasing the ductility of the healing network. When the mass ratio is close to 1:1, the number of thiol groups is close to the metering requirement of the epoxy groups, forming a cross-linked network with a higher density, which is suitable for enhancing the strength after repair. When the mass ratio is 4:1, the thiol groups are slightly excessive, the proportion of flexible segments is increased, and the healing material has better toughness and fatigue resistance, and is adaptable to large strain environments. When the content of epoxy resin increases, the viscosity of the healing agent increases, which may reduce its permeability in the cracks. The proportion of thiol may be appropriately increased according to the actual application to effectively reduce the viscosity and improve the fluidity and fillibility of the healing agent in microcracks.

Further, the catalyst is diphenylphosphonic acid, which can accelerate the cross-linking reaction between epoxy groups and thiol groups in the liquid healing agent and improve the repair efficiency; and the dispersant is polyether-modified siloxane, and is used to improve the dispersibility of the healing agent carrier particles in the prepolymer.

Further, the present disclosure further includes 0.5-5 parts of an additive used for enhancing weather resistance or mechanical performances.

Further, the additive is one or a mixture of more of an antioxidant, an ultraviolet absorber and a flame retardant.

Further, the antioxidant is 2,6-di-tert-butyl-p-cresol, the ultraviolet absorber is benzophenone, and the flame retardant is decabromodiphenylethylene.

The additive above of the present disclosure can enhance the weather resistance, ultraviolet resistance and flame retardancy of the composite material. These additives are selected according to actual application requirements, and can meet the requirements of long-term use in different environments while improving the stability of the material.

The present disclosure further provides a method for preparing the polyurethane composite material with an embedded liquid healing network, including following steps:
(1) injection and encapsulation of a liquid healing agent: heating the epoxy resin at 50-60° C. to a viscous state, slowly adding thiol under continuous stirring to ensure uniform mixing, and continuing stirring for 10-15 min until a uniform and transparent liquid healing agent is formed;
(2) weighing raw materials according to the above parts by weight, mixing the liquid healing agent with the healing agent carrier particles to obtain a mixture, treating the mixture under a vacuum condition for 10-20 min to ensure that the liquid healing agent penetrates into the carrier pores to obtain a carrier injected with the liquid healing agent, rapidly freezing the carrier injected with the liquid healing agent at −40° C., and performing vacuum freeze drying by using a freeze drying device to remove excess solvent and ensure stable storage of the healing agent;
(3) preparation of polyurethane prepolymer: preparing a polyurethane prepolymer with controllable viscosity through reaction of isocyanate and polyol under an action of a catalyst; and
(4) forming of the composite material: ultrasonically dispersing the carrier particles with encapsulated healing agent uniformly in the polyurethane prepolymer, and then forming by a molding, casting or spraying process, and curing at 50-80° C. for 2-6 h to obtain the polyurethane composite material with an embedded liquid healing network.

Further, the preparation method of the healing agent carrier particles includes: dispersing SiO₂ microspheres in anhydrous ethanol to ensure complete suspension of particles, adding 0.1-5% of a silane coupling agent, stirring evenly, refluxing at 60° C. for 2-4 h to allow the silane coupling agent to form a chemical bond with the SiO₂ surface, washing with ethanol for multiple times to remove unreacted silane coupling agent, and finally drying at 80° C. to obtain modified SiO₂ microspheres.

Further, the silane coupling agent is y-aminopropyltriethoxysilane or γ-methacryloxypropyltrimethoxysilane.

Further, in step (2), the vacuum pressure is 10 Pa, the freeze drying temperature is-60° C., and the freeze drying time is 12-24 h.

Further, the composite material prepared by the present disclosure can achieve self-healing under an acid-base environment (pH of 2-12) and a high temperature (within 200° C.) condition.

Through the synergistic effect of the liquid healing agent and the micro-nano carrier, the present disclosure solves the problems of low repair efficiency and long repair time in the case of large-scale damage in the prior art. The high fluidity of the liquid healing agent and the controllable release mechanism of the micro-nano carrier enable the material to respond quickly and achieve efficient repair when damage occurs. Through storing and releasing by the micro-nano carrier, the healing agent can quickly penetrate and fill cracks when cracks occur, and then be quickly cured through the cross-linking reaction of epoxy resin and thiol, thereby restoring the mechanical properties of the material. Compared with the prior art, the present disclosure has significantly shortened repair time, and can maintain a good repair effect under multiple times of damage and complex environmental conditions.

In the technical solution of the present disclosure, the micro-nano carrier adopts SiO₂ microspheres with silanized surface, which have a highly controllable pore structure (see FIG. 1), and can effectively load the liquid healing agent. Through vacuum-assisted injection, the liquid healing agent may be fully filled into the pores of the microspheres, making it stable in storage and evenly distributed. Meanwhile, the nanometer size and high specific surface area of the microspheres ensure that the healing agent is well dispersed inside the material, avoiding local aggregation or sedimentation phenomenon. In addition, the high reactivity of the epoxy group and the thiol group is used to achieve rapid cross-linking and curing after the cracks are filled. When damage occurs, the liquid healing agent is induced by the cracks to be released, filled into the cracks, and reacts rapidly under the action of environmental conditions (such as humidity or temperature) to form a dense cured layer, restoring the integrity and mechanical properties of the material. The low viscosity of the liquid healing agent enables it to quickly penetrate the deep layer of the cracks, and the high activity of the cross-linking reaction thereof further shortens the curing time. Compared with traditional healing materials that require external heating or long-term standing, the liquid healing network can complete the initial repair in minutes.

In the present disclosure, the micro-nano carrier is dispersed in the polyurethane matrix to form a “lattice-like” structure. Each microsphere is a node for storing and releasing the healing agent. When the crack expands, it may gradually trigger the release of multiple healing agent nodes, forming a synergistic repair effect as a whole. This process is similar to information transmission or signal activation in a network system. Each node in the network structure may work independently, and damages in different regions may independently induce the release of the healing agent.

The composite material of the present disclosure may be widely used in various fields of industrial equipment, aerospace, automobile, architecture, flexible electronic equipment, etc., and has significant advantages in terms of damage resistance and service life prolonging.

### BRIEF DESCRIPTION OF DRAWINGS

FIG. 1 shows an image showing surface morphology of a micro-nano carrier provided by the present disclosure; and

FIG. 2 shows images showing morphological changes of the composite material provided by the present disclosure before and after repair, where (a) and (c) are macroscopic and microscopic images before repair, respectively; and (b) and (d) are macroscopic and microscopic images after repair, respectively.

### DETAILED DESCRIPTION OF EMBODIMENTS

The technical solutions in embodiments of the present disclosure will be clearly and completely described below in conjunction with the drawings in the embodiments of the present disclosure. Apparently, the described embodiments are some, but not all, of the embodiments of the present disclosure. Based on the embodiments of the present disclosure, all other embodiments obtained by a person having ordinary skill in the art without paying creative work shall fall within the scope of protection of the present disclosure.

### Example 1

Polyurethane composite material I included the following components: a polyurethane prepolymer 50 g, healing agent carrier particles 10 g, a liquid healing agent 15 g, a catalyst 1 g, a dispersant 0.5 g, and an additive 2 g (antioxidant).

The method for preparing the polyurethane composite material I included:
(1) dispersing SiO₂ microspheres (15 g) in anhydrous ethanol to ensure complete suspension of particles, adding 0.5 g of y-aminopropyltriethoxysilane and stirring evenly, refluxing at 60° C. for 2 h to form a chemical bond between the silane coupling agent and SiO₂, washing with ethanol for several times to remove unreacted coupling agent and drying at 80° C.;
(2) heating epoxy resin (10 g) to 60° C. to make it in a viscous state, slowly adding thiol (3.33 g) and stirring evenly, continuously stirring for 10 min to obtain a liquid healing agent, mixing the obtained liquid healing agent with modified SiO₂ microspheres at a mass ratio of 1.5:1 and treating under a vacuum condition for 10 min to ensure that the liquid healing agent penetrates into the carrier pores, quickly freezing the carrier injected with the liquid healing agent at −40° C., and performing vacuum freeze drying at −60° C. and 10 Pa for 18 h by using a freeze drying device to remove excess solvent to ensure stable storage of the healing agent;
(3) making MDI and polyether polyol react at a molar ratio of 1.9:1, adding the catalyst (1 g), and stirring at 60° C. and 200-500 rpm for 2-4 h to obtain the desired polyurethane prepolymer; and
(4) uniformly dispersing the carrier particles with encapsulated healing agent in the polyurethane prepolymer, ultrasonically dispersing for 30 min, molding by using a molding process, and curing at 50° C. for 4 h to obtain the polyurethane composite material I.

### Example 2

Polyurethane composite material II included the following components: a polyurethane prepolymer 45 g, healing agent carrier particles 12 g, a liquid healing agent 20 g, a catalyst 1.5 g, a dispersant 0.3 g, and an additive 1.5 g (ultraviolet absorber).

The preparation method and use method of the polyurethane composite material II were the same as those in Example 1, to obtain the polyurethane composite material II.

### Example 3

Polyurethane composite material III included the following components: a polyurethane prepolymer 55 g, healing agent carrier particles 8 g, a liquid healing agent 12 g, a catalyst 0.8 g, a dispersant 0.8 g, and an additive 4 g (flame retardant).

The preparation method and use method of the polyurethane composite material III were the same as those in Example 1, to obtain the polyurethane composite material III.

### Example 4

Polyurethane composite material IV included the following components: a polyurethane prepolymer 40 g, healing agent carrier particles 9 g, a liquid healing agent 18 g, a catalyst 1 g, a dispersant 0.4 g, and an additive 3 g (antioxidant).

The preparation method and use method of the polyurethane composite material IV were the same as those in Example 1, to obtain the polyurethane composite material IV.

### Example 5

Polyurethane composite material V included the following components: a polyurethane prepolymer 60 g, healing agent carrier particles 6 g, a liquid healing agent 10 g, a catalyst 1.8 g, a dispersant 0.6 g, and an additive 1 g (ultraviolet absorber).

The preparation method and use method of the polyurethane composite material V were the same as those in Example 1, to obtain the polyurethane composite material V.

### Example 6

Polyurethane composite material VI included the following components: a polyurethane prepolymer 48 g, healing agent carrier particles 10 g, a liquid healing agent 14 g, a catalyst 1.2 g, a dispersant 0.4 g, and an additive 2 g (antioxidant).

The preparation method and use method of the polyurethane composite material VI were the same as those in Example 1, to obtain the polyurethane composite material VI.

### Example 7

Polyurethane composite material VII included the following components: a polyurethane prepolymer 55 g, healing agent carrier particles 10 g, a liquid healing agent 12 g, a catalyst 1 g, a dispersant 0.5 g, and an additive 3 g (flame retardant).

The preparation method and use method of the polyurethane composite material VI were the same as those in Example 1, to obtain the polyurethane composite material VII.

### Example 8

Polyurethane composite material VIII included the following components: a polyurethane prepolymer 53 g, healing agent carrier particles 7 g, a liquid healing agent 13 g, a catalyst 1.5 g, a dispersant 0.6 g, and an additive 4 g (antioxidant).

The preparation method and use method of the polyurethane composite material VIII were the same as those in Example 1, to obtain the polyurethane composite material VIII.

### Example 9

Polyurethane composite material IX included the following components: a polyurethane prepolymer 50 g, healing agent carrier particles 11 g, a liquid healing agent 16 g, a catalyst 1.3 g, a dispersant 0.5 g, and an additive 3 g (flame retardant).

The preparation method and use method of the polyurethane composite material IX were the same as those in Example 1, to obtain the polyurethane composite material IX.

### Example 10

Polyurethane composite material X included the following components: a polyurethane prepolymer 49 g, healing agent carrier particles 9 g, a liquid healing agent 17 g, a catalyst 1.4 g, a dispersant 0.6 g, and an additive 4 g (flame retardant).

The preparation method and use method of the polyurethane composite material X were the same as those in Example 1, to obtain the polyurethane composite material X.

According to the above-mentioned test method, the polyurethane composite materials prepared in individual embodiments were subjected to performance testing. The results of the performance testing are shown in Table 1.

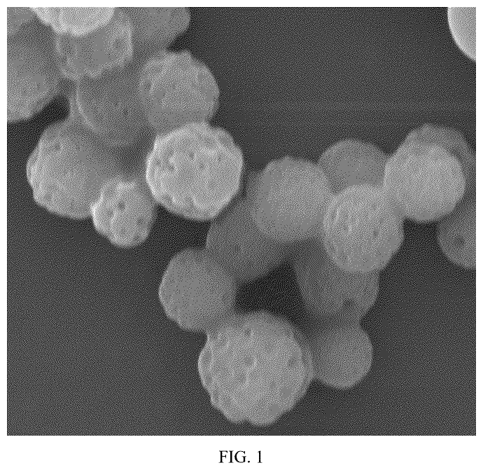

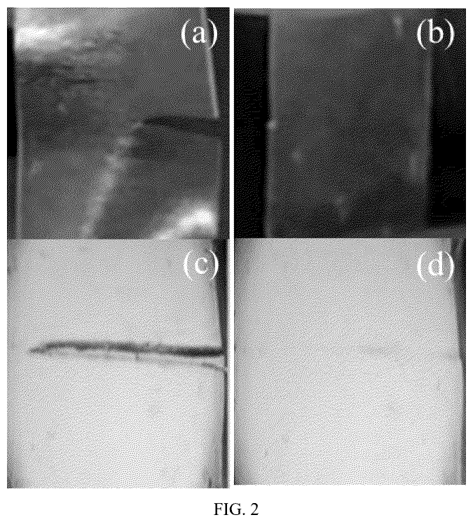

FIG. 1 shows the SEM image of the micro-nano carrier, which has a regular porous surface, indicating that the healing agent thereof has strong storage capacity. The larger the internal volume is, the more the healing agent can be encapsulated. The high storage capacity of the healing agent inside the carrier can ensure the material supply during the self-repair process, thereby improving the repair efficiency. Moreover, the pore size is uniform, and the release rate of the healing agent may be well controlled, which helps to achieve continuous supply during the repair process and ensure that the cracks are completely closed. FIG. 2 shows images showing morphological changes of the composite material before and after repair. The repair efficiency is evaluated by artificially creating cracks. It can be seen from the macroscopic images that the cracked material is almost completely repaired after one minute, indicating that its repair efficiency is high. Meanwhile, the microscopic images further prove that not only the cracks are surface-covered, but the healing agent penetrates the deep layer of the cracks, providing effective structural reinforcement.

It can be obtained from the results of performance testing that the self-repair efficiency of Example 3 is the highest, 96%, and Example 9 has outstanding performance in hardness, impact resistance, tensile strength and self-repair efficiency, and has the best comprehensive performance.

TABLE 1
Coating performance test results

| | | | Impact | Tensile | Self-repair |
|---|---|---|---|---|---|
| Coating | | Pencil | resistance | strength | efficiency |
| performance | | hardness | (cm) | (MPa) | (%) |
| Polyurethane | I | 5H | 40 | 22 | 85 |
| composite | II | 6H | 43 | 24 | 88 |
| material | III | 5H | 42 | 21 | 96 |
| | IV | 6H | 45 | 26 | 89 |
| | V | 5H | 50 | 28 | 91 |
| | VI | 6H | 52 | 31 | 93 |
| | VII | 5H | 48 | 34 | 92 |
| | VIII | 6H | 50 | 30 | 90 |
| | IX | 7H | 55 | 33 | 94 |
| | X | 6H | 54 | 32 | 92 |

Although the embodiments of the present disclosure have been shown and described above, it may be understood that the above embodiments are exemplary and cannot be construed as limiting the present disclosure. A person ordinarily skilled in the art may change, modify, replace and vary the above embodiments within the scope of the present disclosure.

1. A polyurethane composite material with an embedded liquid healing network, comprising following raw materials in parts by weight:
a polyurethane prepolymer 40-60 parts, healing agent carrier particles 5-20 parts, a liquid healing agent 10-30 parts, and a dispersant 0.1-1 parts,
wherein the polyurethane prepolymer is prepared by mixing isocyanate and polyol in a molar ratio of 1.8-2.2:1 under catalyzing of a catalyst; and
the liquid healing agent is prepared by mixing epoxy resin and thiol in a mass ratio of 1-4:1.

2. The polyurethane composite material with an embedded liquid healing network according to claim 1, wherein the healing agent carrier particles are modified SiO₂ microspheres.

3. The polyurethane composite material with an embedded liquid healing network according to claim 1, wherein the catalyst is diphenylphosphonic acid, and the dispersant is polyether-modified siloxane.

4. The polyurethane composite material with an embedded liquid healing network according to claim 1, further comprising an additive 0.5-5 parts.

5. The polyurethane composite material with embedded liquid healing network according to claim 4, wherein the additive is one or a mixture of more selected from the group consisting of an antioxidant, an ultraviolet absorber and a flame retardant.

6. A method for preparing the polyurethane composite material with an embedded liquid healing network according to claim 1, comprising following steps:
(1) injection and encapsulation of a liquid healing agent: heating epoxy resin at 50-60° C. to a viscous state, slowly adding thiol under continuous stirring to ensure uniform mixing, and continuously stirring for 10-15 min until a uniform and transparent liquid healing agent is formed;
(2) weighing raw materials according to the parts in weight, mixing the liquid healing agent with the healing agent carrier particles to obtain a mixture, treating the mixture under a vacuum condition for 10-20 min to ensure that the liquid healing agent penetrates into carrier pores to obtain a carrier injected with the liquid healing agent, rapidly freezing the carrier injected with the liquid healing agent at −40° C., and performing vacuum freeze drying by using a freeze drying device to remove excess solvent to ensure stable storage of the healing agent;
(3) preparation of the polyurethane prepolymer: preparing the polyurethane prepolymer with controllable viscosity through reaction of isocyanate and polyol under an action of the catalyst; and
(4) forming of the composite material: ultrasonically dispersing the carrier particles with the encapsulated healing agent in the polyurethane prepolymer, adding remaining raw materials during the dispersing, then forming through a molding, casting or spraying process, and curing at 50-80° C. for 2-6 h to obtain the polyurethane composite material with an embedded liquid healing network.

7. The method for preparing a polyurethane composite material with an embedded liquid healing network according to claim 6, wherein a preparation method of the healing agent carrier particles comprises: dispersing SiO₂ microspheres in anhydrous ethanol to ensure complete suspension of particles, adding 0.1-5% of a silane coupling agent, stirring evenly, refluxing at 60° C. for 2-4 h to allow the silane coupling agent to form a chemical bond with a SiO₂ surface, washing with ethanol for multiple times to remove unreacted silane coupling agent, and finally drying at 80° C. to obtain modified SiO₂ microspheres.

8. The method for preparing a polyurethane composite material with an embedded liquid healing network according to claim 7, wherein the silane coupling agent is γ-aminopropyltriethoxysilane or γ-methacryloxypropyltrimethoxysilane.

9. The method for preparing a polyurethane composite material with an embedded liquid healing network according to claim 6, wherein in step (2), a vacuum pressure is 10 Pa, a freeze drying temperature is −60° C., and a freeze drying time is 12-24 h.

10. The method for preparing a polyurethane composite material with an embedded liquid healing network according to claim 6, wherein the healing agent carrier particles are modified SiO₂ microspheres.

11. The method for preparing a polyurethane composite material with an embedded liquid healing network according to claim 6, wherein the catalyst is diphenylphosphonic acid, and the dispersant is polyether-modified siloxane.

12. The method for preparing a polyurethane composite material with an embedded liquid healing network according to claim 6, further comprising an additive 0.5-5 parts.

13. The method for preparing a polyurethane composite material with an embedded liquid healing network according to claim 12, wherein the additive is one or a mixture of more selected from the group consisting of an antioxidant, an ultraviolet absorber and a flame retardant.
